(19) United States
(12) Patent Application Publication
(10) Pub. No.: US 2022/0156587 A1
(43) Pub. Date: May 19, 2022

(54) MULTI-HEAD DEEP METRIC MACHINE-LEARNING ARCHITECTURE

(71) Applicant: ObjectVideo Labs, LLC, Tysons, VA (US)

(72) Inventors: Mohammad K. Ebrahimpour, Tysons, VA (US); Gang Qian, McLean, VA (US); Allison Beach, Leesburg, VA (US)

(21) Appl. No.: 17/527,917

(22) Filed: Nov. 16, 2021

Related U.S. Application Data
(60) Provisional application No. 63/114,172, filed on Nov. 16, 2020.

(51) Int. Cl. G06N 3/08; G06N 5/04

(52) U.S. Cl. CPC G06N 3/08; G06N 5/04

(57) ABSTRACT

Methods, systems, and apparatus, including computer programs encoded on a computer storage medium, for implementing a multi-head deep metric machine-learning architecture. The architecture is used to perform techniques that include obtaining multiple features that are derived from data values of an input dataset and identifying, for an input image of the input dataset, global features and local features among the features. The techniques also include determining a first set of vectors from the global features and a second set of vectors from the local features; computing, from the first and second sets of vectors, a concatenated feature set based on a proxy-based loss function and pairwise-based loss function. A feature representation that integrates the global features and the local features are generated based on the concatenated feature set. A machine-learning model is generated and configured to output a prediction about an image based on inferences derived using the feature representation.

### CROSS REFERENCE TO RELATED APPLICATION

This application claims the benefit of U.S. Provisional Application No. 63/114,172, filed on Nov. 16, 2020, which is incorporated herein by reference in its entirety.

### BACKGROUND

This specification relates to generating sets of features using neural networks.

Neural networks are machine-learning models that employ one or more layers of operations to generate an output, e.g., a classification, for a received input. Some neural networks include one or more hidden layers in addition to an output layer. The output of each hidden layer is used as input to the next layer in the network, i.e., the next hidden layer or the output layer of the network. Some or all of the layers of the network generate an output from a received input in accordance with current values of a respective set of parameters.

Some neural networks include one or more convolutional neural network (CNN) layers. Each convolutional neural network layer has an associated set of kernels. Each kernel includes values established by a neural network model created by a user. In some implementations, kernels identify particular image contours, shapes, or colors. Kernels can be represented as a matrix structure of weight inputs. Each convolutional layer can also process a set of activation inputs. The set of activation inputs can also be represented as a matrix structure.

### SUMMARY

For machine learning, feature learning is a set of techniques that allows a system to automatically discover representations needed for feature detection or classification from raw data. Feature learning can be an automated process, e.g., replacing manual feature engineering, that allows a machine to both learn a set of features and use the features to perform a specific task. In some examples, the specific task can involve training a classifier, such as a neural network classifier, to detect characteristics of an item or document.

A feature is generally an attribute or property shared by independent units on which analysis or prediction is to be done. For example, the independent units can be groups of image pixels that form parts of items such as images and other documents. The feature can be an attribute of an object depicted in an image, such as a line or edge defined by a group of image pixels. In general, any attribute can be a feature so long as the attribute is useful to performing a desired classification function of a model. Hence, for a given problem, a feature can be a characteristic in a set of data that might help when solving the problem, particularly when solving the problem involves making some prediction about the set of data.

In view of the above context, this document describes a method of training, tuning, or otherwise configuring neural networks to perform a given task. More specifically, techniques are described for an improved method of learning semantic distance metrics based on a combination of image representations for both global and local features of an input image. The distance metrics can be used to configure or train a machine-learning model for performing tasks that relate to image processing. For example, the distance metrics can be used to refine an existing analytical approach that is applied by a model to execute tasks such as content-based image retrieval, face verification, or person re-identification as well as processes associated with few-shot learning and representation learning. To implement the techniques and methods disclosed in this document, an efficient deep-metric learning system is described, which includes a special-purpose machine-learning architecture.

The machine-learning architecture includes an encoder module that is operable to encode an input image to a range of low-level to high-level features. Sets of features are obtained using the encoder module and the obtained features are then enhanced based on processing that occurs at a second-order attention block of the architecture. Multiple learners of the architecture are configured to map the enhanced features to a final embedding space of the system. The system is operable to concatenate the low-level and high-level features in response to enhancing the respective sets of features. The concatenated feature sets are then mapped to the embedding space based on application of one or more special-purpose loss functions.

Other implementations of this and other aspects include corresponding systems, apparatus, and computer programs, configured to perform the actions of the methods, encoded on computer storage devices. A computing system of one or more computers or circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The subject matter described in this specification can be implemented in particular embodiments to realize one or more of the following advantages. The techniques in this document can be used to obtain accurate data models that are optimized for certain image processing tasks, but that requires a shorter duration to be fully trained relative to prior training approaches. Using these data models, the disclosed techniques can allow for improvements in processing outcomes for verification and identification tasks as well as fast and accurate similarity searching across content that spans multiple images. For instance, an example system can implement the techniques for image retrieval, face verification, person re-identification, and vehicle re-identification on surveillance cameras.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 shows an architecture of an example deep-metric learning system.

FIG. 2A shows an example of a processing pipeline of the system of FIG. 1.

FIG. 2B shows an example metric-learning architecture with local and global features.

FIG. 3 is an example second-order attention block of the system of FIG. 1.

FIG. 4 is a block diagram representation of example multi-head learners.

FIG. 5 shows examples of high-level and low-level features.

FIG. 6 shows an example process for training a machine-learning model based on a multi-head deep metric learning approach.

FIG. 7 shows a diagram illustrating an example property monitoring system that includes the deep-metric learning system of FIG. 1.

Like reference numbers and designations in the various drawings indicate like elements.

### DETAILED DESCRIPTION

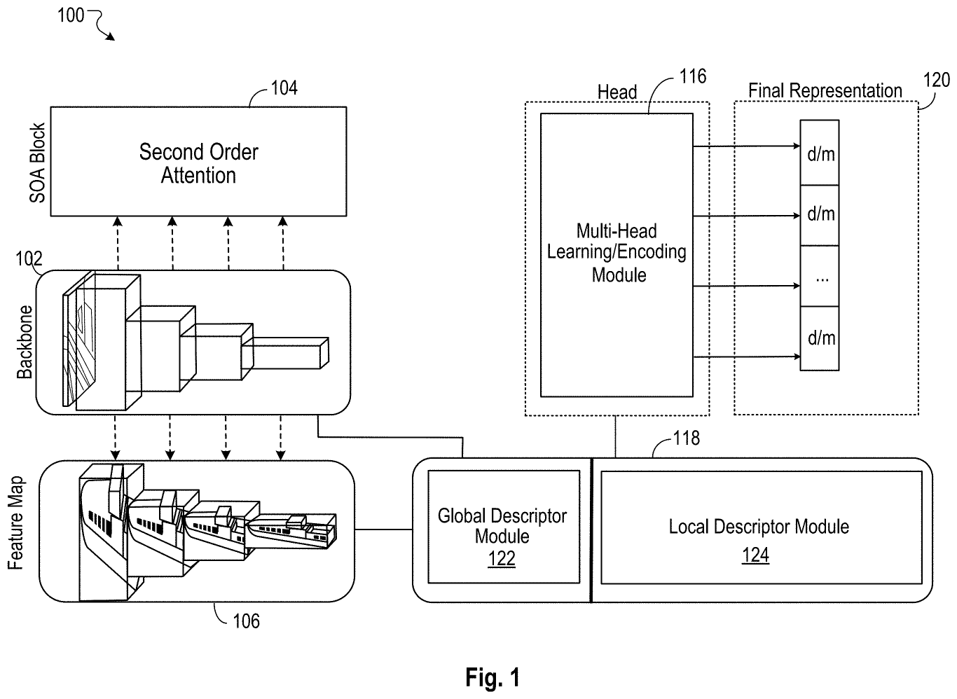

FIG. 1 shows a representative architecture of an example deep-metric learning (DML) system 100. The system 100 includes a backbone 102, a second-order attention block 102, and a feature map 106. The backbone 102 can include one or more neural networks, such as artificial neural networks that each include multiple layers. In general, each layer of the neural network is used to process sets of inputs to generate an output for the layer. Outputs of one or more sets of layers can represent output activations that correspond to activations of neurons in an artificial neural network.

In some implementations, the backbone 102 includes one or more artificial neural networks (“NNs”) that is configured (pre-trained) to generate sets of features from an input. For example, an artificial NN can be pre-trained to perform one or more data analysis functions for feature engineering with respect to a portion of input data such as an image or a region of an image. In view of this, the pre-trained NN can have sets of features or feature vectors that are highly-dimensional. Features can be used by the neural network to perform various functions relating to, for example, image recognition or object recognition. In some implementations, features are pre-computed, stored, and later accessed for certain types of applications where the target task evolves over time.

Convolutional neural networks (CNNs) have been successful in computer vision and machine learning and have helped push the frontier on a variety of problems. The success of CNNs is attributed to their ability of learning a hierarchy of features ranging from very low-level images features, such as lines and edges, to high-level semantic concepts, such as objects and parts. As a result, pre-trained CNNs can be configured as effective and efficient feature generators. Thus, CNNs can be widely used as a feature-computing module in larger computer vision and machine-learning application pipelines, such as video and image analysis.

The deep-metric learning system 100 includes a machine-learning architecture that is configured to learn semantically meaningful representations from an input image. Learning semantically meaningful representations is often an important step in numerous computer vision applications such as content-based visual retrieval, face verification, person or vehicle re-identification, and representation learning. Deep Convolutional Neural Networks (CNNs) are known to be effective in a large spectrum of computer vision tasks.

In some implementations, the system 100 employs a Deep-Metric Learning (DML) based framework to train one or more neural networks of the system. The neural networks are trained to map various classes of data to a lower-dimensional embedding space (described below) in which similar data (e.g., data from the same class) are grouped closer together and the dissimilar data (e.g., data from different classes) are further away. In some cases, rich data representations and use of special loss functions can be required to attain these mappings in the embedding space.

High image retrieval requires two types of image representations: global and local features. As discussed above, features can represent attributes shared by independent units, such as groups of image pixels forming items in an image, on which analysis or prediction is to be performed. In some cases the features are attributes of an object depicted in an image, such as a line or edge defined by a group of image pixels. In this context of image processing, a global feature, also commonly referred to as a “global descriptor,” summarizes the contents of an image abstractly. Global descriptors/features are often obtained from computations associated with the deep layers in CNNs. The global descriptors often only involve the most abstract information about the content of the image. With this abstract information, crucial identifiers such as geometry and spatial location information is lost. On the other hand, local features involve descriptors and geometry information about specific image regions. Local features are especially useful to match or perform recognition tasks on images depicting rigid objects.

Generally, global features are more useful in performance of machine-learning tasks relating to recall, whereas local features are better in performance of machine-learning tasks relating to precision. Global features can be used to learn similarity across different poses or regions, and particularly regions where local features would not be effective in providing the capability to find correspondences.

Referring again to FIG. 1, to obtain the best of both worlds, this specification describes an example machine-learning retrieval system (e.g., system 100) that is operable to employ a hybrid approach that takes advantage of the computational benefits afforded by the use of both global and local features in the final embeddings of an example neural network, such as the neural network implemented in system 100. Such a hybrid approach can be effective at addressing challenges in visual localization and instance-level recognition.

The system 100 employs self-attention or second-order attention in an example feature space. For instance, the second-order attention block 104 can be utilized as a method of spatial auto-correction enhancement. In some implementations, the second-order attention block 104 includes multiple respective second-order attention blocks that are each operable to improve patch descriptors for image matching, and can be adopted to obtain such improvements in different vision tasks. While some deep-learning based global descriptors provide ways to aggregate features into a global vector, these deep-learning approaches do not explore or provide the correlations between low-level and high-level features within feature maps simultaneously. As previously mentioned, the combination of low level and high level features are necessary in a typical image retrieval system.

As mentioned above, attaining desired mappings in an embedding space can require not only rich representations but also special loss functions. For example, the neural network of system 100 are trained to project data onto an embedding space in which semantically similar data (e.g., images of the same class) are closely grouped together. Such a quality of the embedding space is given primarily by loss functions used for training the networks. Thus, loss functions are another important factor in the performance of DML. The loss functions provide a powerful supervisory signal based on the problem objectives.

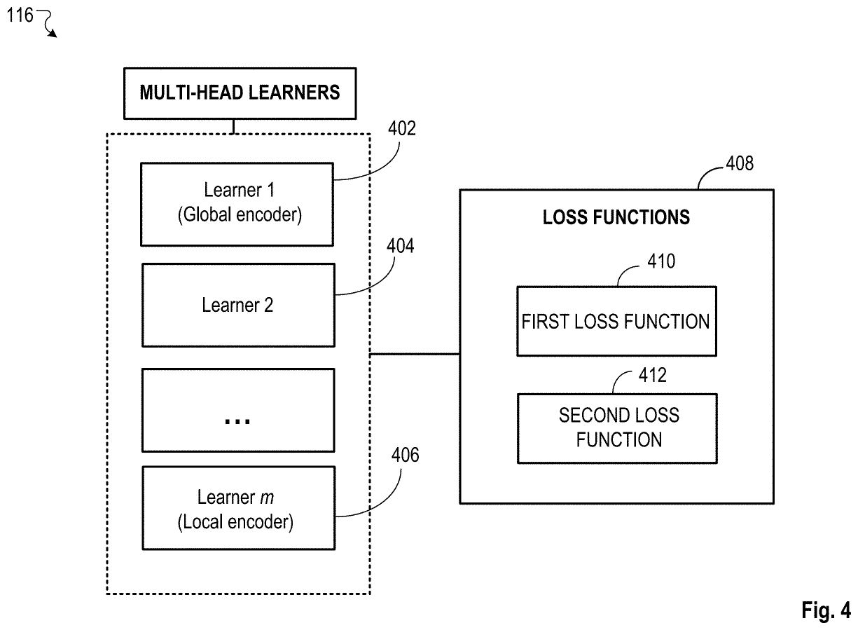

Loss functions in the DML problems addressed by the system 100 can be classified into two groups, pairwise-based, and proxy-based. The pairwise-based losses are built upon comparing the pairwise distances between data in the embedding space. An example is Contrastive pairwise-based loss, which aims to minimize the distance between a pair of data if their class labels are the same and to separate them otherwise. This is described in more detail below with reference to the FIG. 4. Some pair-based losses consider a group of pairwise distances to handle relations between more than two data. For example, an extension pairwise-base loss is a group of pairwise distances that provide a stronger supervisory signal.

The pairwise-based losses provide a strong supervisory signal for model training by comparing data-to-data relations. However, pairwise-based losses often require a tuple of data as a unit input, which leads to losses that cause prohibitively high training complexity. For example, the complexity can be represented as M² or M³, where M is the number of training data and leads to slow convergence. Furthermore, some tuples do not contribute to training or even degrade the quality of the learned embedding space. Thus, the pairwise-based loss functions suffer from two problems: sample mining/complexity and slow convergence. The issues also involve the quality of data points (tuples) that results in weak contribution to training and degraded quality of the learned embedding space. To resolve these issues, learning with the pairwise-based losses often requires sampling techniques that have to be hand tuned. This hand tuning increases the risk of overfitting. Also, the data-to-data comparison leads to significantly slow convergence rates due to extensive computations.

The proxy-based losses resolve the above issues by introducing a limited number of proxies. A proxy is representative of a subset of training data and learned as a part of the network parameters. Existing losses in this category consider each data point as an anchor, associate the data point with proxies instead of other data points, and encourage the anchor to be close to (e.g., adjacent) proxies of the same class and apart (e.g., far apart) from those of different classes. Since the number of proxies is substantially smaller than the data-points, the proxy-based models or losses enjoy faster convergence rates than the pairwise-based losses. However, proxy-based models are associated with data-to-proxy relations and miss the rich supervisory information from data-to-data relations.

Referring again to FIG. 1, to address the above challenges related to pairwise-based and proxy losses, this specification describes a multi-head network that benefits from the fast convergence of the proxy-based models and rich data-to-data relation of the pairwise-based models. More specifically, the system 100 includes a multi-head module 116 that represents the multi-head network and a descriptor module 118 configured to combine global and local descriptors. The system 100 is configured to use both proxy-based and pairwise-based loss functions in its multi-head network, without introducing or requiring hyper-parameters for tuple sampling. In some implementations, the descriptor module 118 is integrated, or included, in the multi-head module 116 and represents a portion of computing logic of the multi-head module 116.

The hybrid DML approach implemented at system 100 to train machine-learning models involves the use of a second-order attention mechanism (i.e., block 104) to exploit the correlation between features at different spatial locations. Based in part on the second-order attention block's augmenting or enhancing of both local and global descriptors, the descriptor module 118 is operable to then combine (e.g., concatenate), using its sub-modules 122, 124, both global and local descriptors to produce a final descriptor that contains the content information as well as the geometry and spatial information to improve feature descriptors for image retrieval and matching. In some implementations, the descriptor module 118 of system 100 includes DML algorithms that can be divided into three groups based on the use of descriptors: local descriptors, global descriptors, and joint local and global descriptors.

This final descriptor corresponds to the final representation 120 that is generated as an output of the multi-head module 116. Based on the advantages of this hybrid DML approach, a standard embedding network of system 100 trained with a combined pairwise- and proxy-based loss can achieve improved accuracy and rapid convergence over prior training approaches.

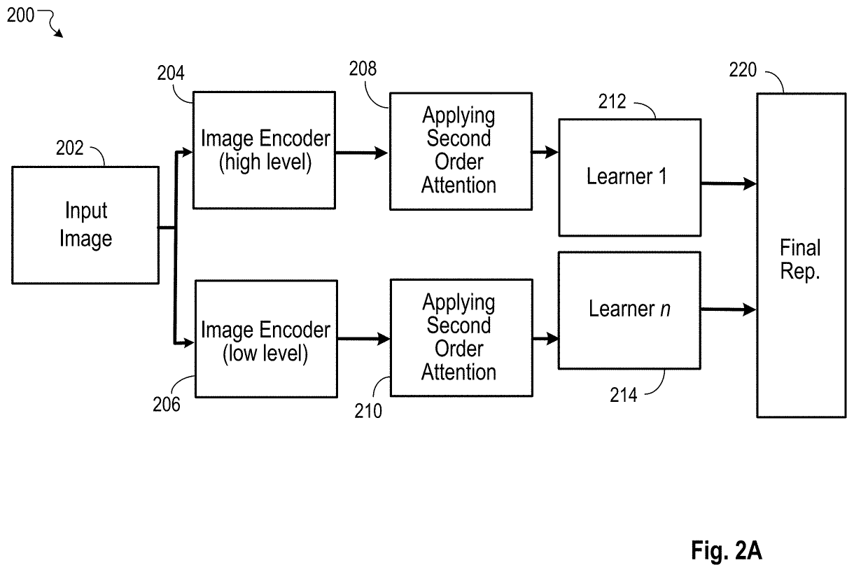

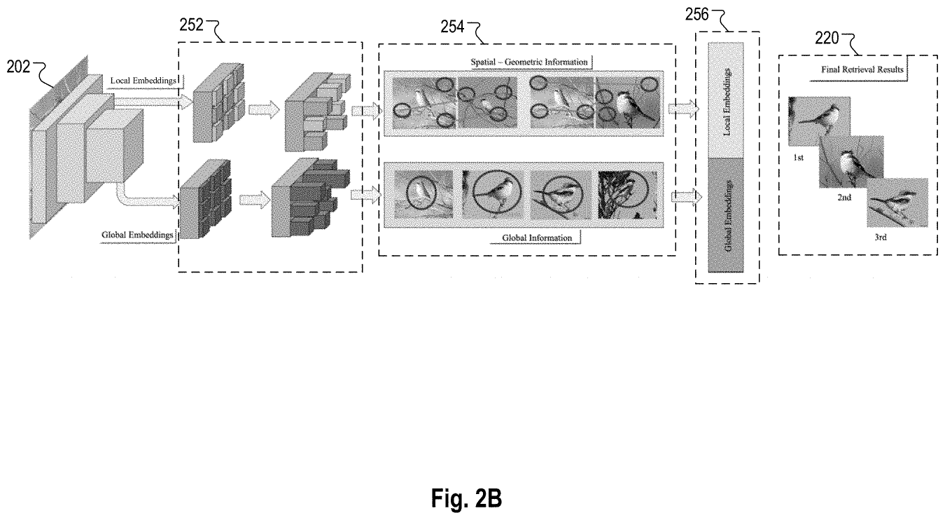

FIG. 2A shows an example processing pipeline 200 of the system of FIG. 1.

The processing pipeline 200 uses the multi-headed network discussed in the example of FIG. 1 to leverage both pairwise-based and proxy-based methods of computing loss. More specifically, the processing pipeline 200 leverages the rich data-to-data relations mentioned above and enables fast and reliable convergence. For example, the pipeline 200 receives an input image 202 and processes the image using respective image encoders 204, 206. In some implementations, the input image 202 is obtained from a dataset (e.g., an input dataset) that includes multiple images, such as annotated images of a training set used to train a neural network or to obtain a feature set for a neural network.

The encoders can be CNNs (e.g., pre-trained CNNs) that are configured to generate a range of low- to high-level convolutional features. In general, the features may be derived from processing performed on data values (e.g., image pixel values) of the dataset. For at least one input image of the input dataset, the system 100 is operable to identify global features and local features from among the multiple low-level and high-level features generated using the CNN encoders 204, 206. Identifying the global features and the local features includes: encoding, using an encoder module of the architecture, the input image 202 to an attribute range. The range can span from low-level descriptors of an input image to high-level descriptors of an input image.

The pipeline 200 includes respective second-order attention blocks 208, 210. The second-order attention block 208 is utilized to obtain more refined high-level features, whereas the second-order attention block 210 is utilized to obtain more refined low-level features. The system 100 can determine a first set of vectors from the global features and a second set of vectors from the local features. For example, using the processing pipeline 200, the system 100 can generate an enhanced set of global features in response to processing the global features by a first second-order attention block 208. The system 100 can then determine the first set of vectors from the enhanced set of global features.

Likewise, the system 100 can generate an enhanced set of local features in response to processing the local features by a second second-order attention block 210. The system 100 can then determine the second set of vectors from the enhanced set of local features. In some implementations, the second-order attention blocks 208, 210 are used to explore the second-order information among the spatial locations in both local (high-level) descriptors and global (low-level) descriptors, respectively. For example, an enhanced set of global features can include second-order information from spatial locations in high-level descriptors of an input image, whereas an enhanced set of local features can include second-order information from spatial locations in local-level descriptors of the same input image.

The pipeline 200 includes at least a first learner 212 and a second learner 214. In some implementations, the pipeline 200 includes multiple learners that cooperate to map the enhanced features to a final embedding space of the system 100. The system 100 uses the multiple learners to compute a concatenated feature set from the first and second sets of vectors based on a proxy-based loss function and pairwise-based loss function. In some implementations, the concatenated feature set can be generated or computed based on pooling operations (e.g., average pooling or max pooling) performed using one or more pooling layers of the multiple learners.

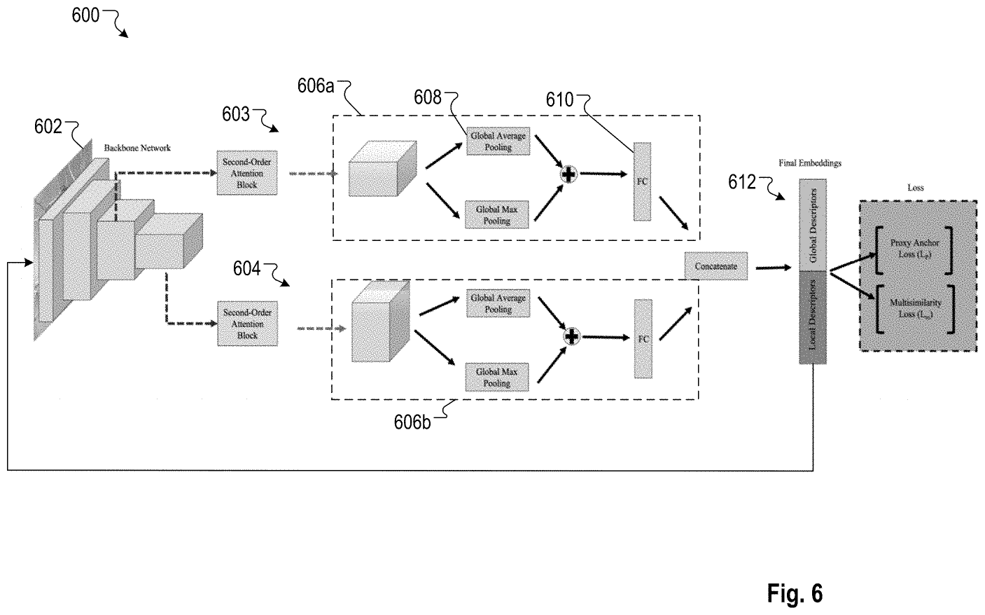

As described below with reference to FIG. 6, for each learner the system 100 can first perform global average pooling and global max pooling in the spatial dimensions to obtain two or more vectors from a feature map (e.g., enhanced feature map). The system 100 can then add the two or more vectors. The resulting vectors output from the addition operation are passed through a fully connected layer to obtain the feature vector from that particular learner. The feature vectors from each of the multiple learners/learnings are concatenated to form the final feature vector. In some implementations, the operation of concatenation of two vectors a and b is to merge the two vectors into one vector by appending b to the end of a. For example, a=(v1,v2) and b=(v3,v4) so that concat(a,b)=(v1,v2,v3,v4).

In general, loss functions are used during model training to constrain or reduce prediction errors. In one example, application of a loss function can involve use of at least three image types: i) an anchor image, ii) a positive image, and iii) a negative image. During an example learning phase of a neural network model, system 100 may seek to produce embeddings such that the positive image gets close to the anchor image in a feature/embedding space of the neural network, while the negative is pushed away from the anchor image in the feature space of the neural network. Embeddings learned from this training phase can then be used to compute image similarity outputs or results and predictions for other image processing tasks.

The system 100, including its processing pipeline 200, can include N number of learners where N is an integer greater than 1. In some implementations, the processing pipeline 200 includes computing logic that defines a new loss function by utilizing a number of different multi-head learners from a variety of groups. The computing logic may be integrated in the multi-head module 116.

Based at least on the learners 212, 214, the processing pipeline 200 combines lower-level features and higher-level features to a single final representation 220. For example, the processing pipeline 200 can generate the concatenated feature set (as described above) based on application of one or more special-purpose loss functions using the learners 212, 214 and then map the concatenated feature set to the embedding space. In some implementations, the system 100 generates a feature representation based on the concatenated feature set. The feature representation can be a single final representation that integrates the global features and the local features described earlier.

In some implementations, the system 100 generates a first set of embeddings corresponding to the first set of vectors (described above) based on the proxy-based loss function and the pairwise-based loss function. The system 100 can also generate a second set of embeddings corresponding to the second set of vectors (described above) based on the proxy-based loss function and the pairwise-based loss function. Generating the feature representation can include generating, from the first and second sets of embeddings, a final embedding output that is representative of content information, geometry information, and spatial information of the input image 202.

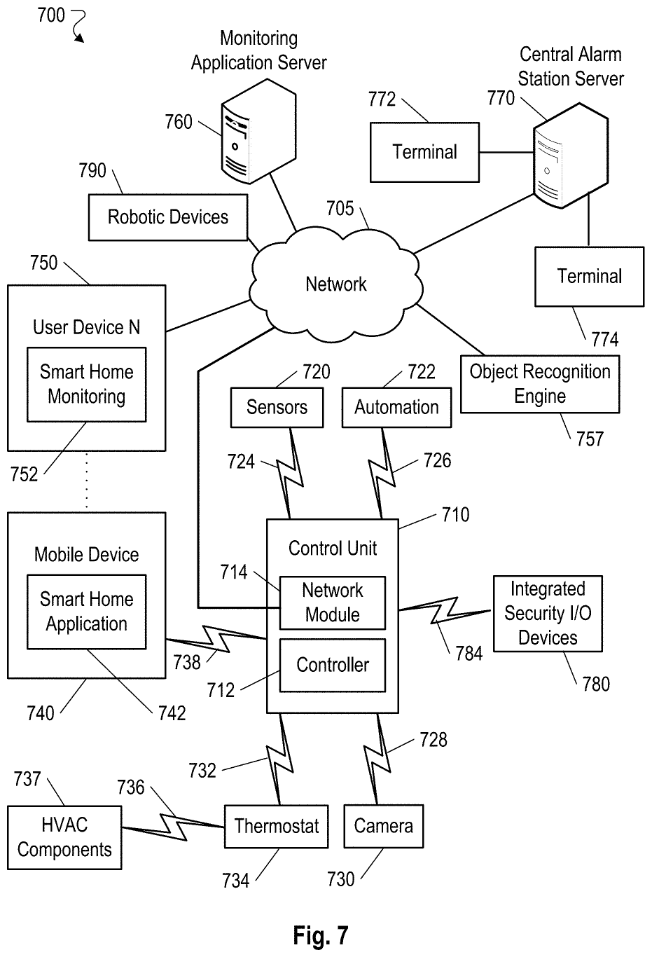

The system 100 is operable to generate a machine-learning model that is configured to output a prediction about an image based on inferences that are derived using the feature representation. The machine-learning model can form the basis of an example object recognition engine (described below at FIG. 7) that can process sets of images to yield predictions about the contents of those images. Relative to prior approaches, the machine-learning model can be optimized to render more accurate classification outcomes because it learns from a broader set of information based on the combined use of at least proxy-based and pairwise-based loss functions.

Using this combination, the system 100 can simultaneously benefit from the semantic information as well as the spatial information and geometric verification of a given input image 202. The system 100 is operable to concatenate the low-level and high-level features in response to enhancing the respective sets of features based on processes performed by the second-order attention blocks 208, 210.

FIG. 2B shows an example metric-learning architecture 250 with a first feature-processing block 252, an information block 254, and a second feature-processing block 256. The information block 254 shows respective examples of: i) spatial-geometric information corresponding to the local embeddings provided from the first feature-processing block 252 and ii) global information corresponding to the global embeddings provided from the first feature-processing block 252.

The architecture 250 can represent a machine-learning model that jointly extracts deep local and global features/embeddings. The extracted features are further enhanced spatially by a second-order attention mechanisms, which can occur at the first processing block 252. The final embedding involves the concatenation of local and global representations to be used by an example retrieval system. The concatenation of the local and global representations can occur at the second feature-processing block 256. For example, given an input image, the concatenated representations are used by the system 100 to efficiently select images that are most similar to the input image, based on both the content and the spatial information of the input image.

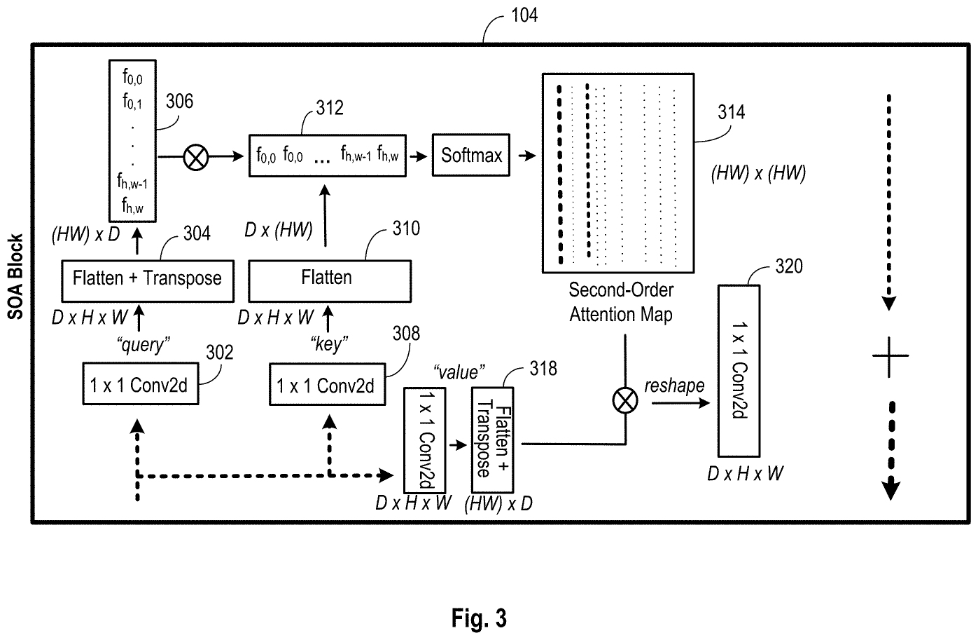

FIG. 3 is an example second-order attention block 104 of the system of FIG. 1. Referencing the second-order attention block 104, each location (i, j) in map f correspond to (i_{I}, j_{I}) when projected onto the input image I. Assuming a rectangular receptive field R [Rₓ, R_{y}] each vector f_{i,j}∈f is a function of the input pixels I_{R} included in the receptive field R. A non-local block is adopted to incorporate second-order spatial information into the feature pooling. A visualization of the concept is shown in the example of FIG. 3. First, the system 100 generates two projections of feature map f termed query q head, and key k head, each obtained through 1×1 convolutions (302, 308, respectively) which possible number of channel reduction. Each of the respective tensors associated with the convolution blocks 302 and 308 are then flattened (304, 310, respectively). By flattening both tensors, the second-order attention block 104 obtains q (306) and k (312) with each with shape d×hw. A second-order attention map z (314) is then computed through

$$z = softmax ( {α q}^{T} k ) , \qquad ( 1 )$$

where α is a scaling factor and z has shape hw×hw, enabling each f_{i,j} to correlate with features from the whole map f A third projection of f is then obtained by value V head (318), in a similar way to q and k, but resulting in shape hw×d. Finally, f^{so} map is obtained from the first-order features f by the second-order attention

$${f}^{so} = f + ∅ ( z \times v ) , \qquad ( 2 )$$

where φ is another 1×1 convolution (320) to control the influence of the attention. Thus, a new feature f_{i,j}^{so} in the second-order map f (reshaped to h×w×d), is a function of features from all locations in f

$${f}_{i , j}^{so} = g ( {z}_{ij} ⊙ f ) \qquad ( 3 )$$

where g denotes the combination of all convolutional operations within the non-local block. Each feature f_{i,j}^{so} can be expressed as a function of the full input image f_{i,j}^{so}=φ(i, j, I), viewed from location (i, j), with φ as the new FCN with the non-local block(s).

In order to aggregate deep activations in both global and local features, the system includes a combination of Global Mean Pooling (GMP) and Global Average Pooling (GAP) as follows:

$$f = \frac{1}{W \times H} {\sum }_{i ∈ W , j ∈ H} {f}^{so} + {max}_{( i ∈ W , j ∈ H )} {f}^{so} \qquad ( 4 )$$

After the aggregation, the aggregated representation is whitened. The aggregated representation is integrated into a model of the system 100 with a fully-connected layer F∈C_{f}^{so}×D having a learned bias b_{f}∈C_{f}, which C_{f}^{so} indicates the number of channels in the f^{so} and D is the desired dimension of the embedding space.

In some implementations, the dimension of embedding vectors is a factor that controls a trade-off between speed and accuracy in image retrieval systems. The system 100 can include trained models with embedding dimensions that vary from 64 to 2048. A particular model's performance, with respect to the disclosed special loss function, can be fairly stable when a dimension of the model's embedding space is equal to or larger than 128. In some cases, performance of the model on a specific dataset (e.g., Cars-196) improves until reaching 1024 dimensional embedding. In some other cases, the model's performance on a different dataset (e.g., CUB-200-2011) consistently increases with an increase in the embedding dimension, which shows that a dataset with more information can help the model's retrieval performance.

FIG. 4 is a block diagram representation of example multi-head learners, which may be included in, or accessible by, the multi-head module 116. As discussed above, the system 100 includes a multi-head network that benefits from the fast convergence of the proxy-based models as well as the rich data-to-data relation of pairwise-based models. More specifically, the multi-head module 116 can represent a multi-head network that is configured to use both proxy-based and pairwise-based loss functions 408. As discussed below, local and global features can be processed using both proxy and pairwise loss functions. For example, during the system model training, a set of global features and a set of local features are first concatenated and then a final set of concatenated feature vectors can be passed to both loss functions, such as loss functions 410, 412.

For the proxy anchor loss, in some implementations, the data used in loss computation includes the following: i) X, the set of embedding vectors extracted from a current batch of input images; ii) class labels for each embedding vector in X; iii) P, the set of all proxies (one for each object class) and trained as part of the model parameters, including P⁺ which indicates the set of positive proxies and has samples from the same classes included in the current batch X. For each proxy p, X can be divided into two subsets of embedding vectors, the set of positive Xₚ⁺ (training samples with same class label asp) and negative Xₚ⁻=X−Xₚ⁺.

For the pairwise loss, in some implementations, the data used in the loss computation includes: i) X, the set of embedding vectors extracted from the current batch of input images, and ii) the corresponding class labels for each embedding vector in X. For each training sample xi, according to the class labels of all the samples in the training batch X, X can be split into two subsets, the positive set Pᵢ and the negative set Nᵢ, where Pᵢ contains the training samples (e.g., images) that share the same class label asxᵢ, and Nᵢ contains the remaining training samples that have classes labels different from the class label of xi.

The multi-head module 116 includes multiple learners 402, 404, 406 that cooperate to map the enhanced features to a final embedding space of the system 100 based on application of a particular loss function 410, 412. In the example of FIG. 4, the multi-head module 116 includes at least a learner 402 that functions as a global encoder and another learner 406 that functions as a local encoder. In addition to the learners 402, 406, the multi-head module 116 can include M number of learners (404) where M is an integer greater than 2. These M number of learners may include any combination of proxy-based or pairwise-based models. Other comparable models are also within the scope of this disclosure. The multi-head module 116 integrates or accesses computing logic for defining one or more new loss functions based at least on utilization of the different multi-head learners 402, 404, 406.

The system 100 is configured to use one or more multi-head deep metric learning loss functions 408 to generate a respective set of vectors for each of the high-level and low-level features. For example, using the multi-head module 116, the system 100 can leverage a broad range of loss functions 408 from proxy-based (410) to pairwise-based (412) categories. In some implementations, the multi-head module 116 can use a proxy-anchor loss function (410) from the proxy-based category due to its performance and high convergence speed.

The system 100 can also use soft-triplet loss function (412) and multi similarity losses from the pairwise group to take advantage of comparing real data points together in order to guide computations for an error correction signal generated using the multi-head module 116. Proxy-Anchor loss provides effective proxy-based losses in DML, can handle the entire data in the batch, and associates data with each proxy.

The system 100 is configured to employ a multi-headed loss function. More specifically, the multi-head module 116 is configured to overcome the limitation of both proxy-based and pairwise-based models (discussed above) by combining the proxy-anchor loss from the proxy-based group with the Multi-similarity loss from the pairwise-based category.

Regarding proxy-based loss, the system 100 can use a proxy-anchor loss function that assigns a proxy for each class based on a standard proxy assignment setting of the proxy-anchor, and is formulated as:

$${ℓ}_{p} ( X ) = \frac{1}{\vert {P}^{+} \vert} {\sum }_{p ∈ {P}^{+}} log ( 1 + {\sum }_{x ∈ {X}_{p}^{+}} exp ( - α ( s ( x , p ) - δ ) ) ) + \frac{1}{\vert P \vert} {\sum }_{p ∈ P} log ( 1 + {\sum }_{{X}_{p}^{-}} exp ( α ( s ( x , p ) + δ ) ) ) , \qquad ( 5 )$$

where δ>0 is a margin, α>0 is a scaling factor, P indicates the set of all proxies, and P⁺ denotes the set of positive proxies of data in the batch. Also, for each proxy p, a batch of embedding vectors X is divided into two sets: X⁺, the set of positive embedding vectors of p, and Xₚ⁻=X^{p}−Xₚ⁺.

Regarding pairwise-based loss, the system 100 uses the Multi-similarity loss as a pairwise-based loss since it considers the Self-similarity, negative, and positive relative similarities relative to a given input, such as an input image. The loss function is formulated as:

$${ℓ}_{m} ( X ) = \frac{1}{m} {\sum }_{i = 1}^{m} ( \frac{1}{γ} log ( 1 + {\sum }_{k ∈ {P}_{i}} exp ( - γ ( {S}_{i , k} - σ ) ) ) + \frac{1}{β} log ( 1 + {\sum }_{k ∈ {N}_{i}} exp ( β ( {S}_{i , k} + σ ) ) ) , \qquad ( 6 )$$

where γ, β, and σ are hyper-parameters, and m is the number of samples in the batch. S_{i,j} indicates the pairwise similarity between xᵢ and xⱼ. Pᵢ is a positive sample set containing samples that share the same class label as sample xᵢ. Nᵢ is the negative sample set of xᵢ. As noted above, the system 100 is configured to use both proxy-based and pairwise-based loss functions in its multi-head network without introducing or requiring additional hyper-parameters for tuple sampling.

In general, γ and β are normalization parameters and σ is the similarity margin so that larger gradients (e.g., leading to heavier model adjustment) will be produced by positive pairs with similarity <σ and negative pairs with similarity >−σ. Tuple sampling involves use of careful data sampling methods that usually include some additional hyper-parameters to select strong training tuples. The improved model training and data processing approaches proposed in this document, and involving equation 6, do not need such careful data sampling, thus no additional hyper-parameters are required for data sampling.

For pairwise-based losses, Contrastive loss and Triplet loss are examples of loss functions for pairwise-based DML. Contrastive loss takes a pair of embedding vectors as its input and aims to pull them together if they are of the same class and push them apart otherwise. Triplet loss considers a data point as an anchor. Each anchor is associated with a positive (e.g., an embedding with the identical class label to anchor) and a negative data point (e.g., an embedding with different class labels) and involves the distance of the anchor-positive pair to be smaller than that of the anchor-negative pair in the embedding space.

Enhancements on the pairwise-based losses aims to consider higher-order relations between data and reflect their hardness by associating anchors with multiple negative data points. For instance, the N-pair loss and Lifted Structure loss associate an anchor with a single positive and multiple negative data points to reduce the risk of having a tuple with a poor contribution to training of a model. In some implementations, these losses do not utilize the entire data in a batch, which consequently may translate to a loss of information during training. To address this issue, Ranked List loss can be used, which takes into account all positive and negative data in a batch and aims to separate the positive and negative sets. MultiSimilarity loss also considers every pair of data in a batch and assigns a weight to each pair according to three complementary types of similarity to focus more on useful pairs for improving performance and convergence speed.

As noted above, pairwise-based losses are rich in terms of data-to-data relations. However, the number of tuples can grow polynomially with the number of training data, leading to prohibitive complexity and slow convergence. In addition, a large number of tuples may not be effective and can even degrade the quality of the learned embedding space. To address this issue, most pairwise-based losses rely on tuple sampling or sample mining techniques. However, these techniques involve hyper-parameter tuning and may increase the risk of over-fitting.

For proxy-based losses, the multi-head module 116 can employ proxy-based metric learning which aims to address the complexity and slow convergence issue of the pairwise-based losses. The proxy-based methods infer a small set of proxies to capture the global structure of an embedding space and assign each data point to relevant proxies instead of the other data points during training. Since the number of proxies is significantly smaller than that of the training data, the training complexity can be reduced substantially. The first proxy-based loss is Proxy-NCA, which is an approximation of Neighborhood Component Analysis (NCA) using proxies. In its standard setting, Proxy-NCA loss assigns a single proxy for each class, associates a data point with proxies, and encourages the positive pair to be close and negative pairs to be far apart.

SoftTriple loss, an extension of the SoftMax loss for classification, is similar to Proxy-NCA yet assigns multiple proxies to each class to reflect intra-class variance. Manifold Proxy loss is an extension of N-pair loss using proxies and improves the performance by adopting a manifold-aware distance instead of Euclidean distance to measure the semantic distance in the embedding space. While using proxies in these losses help improve training convergence greatly, the use has an inherent limitation of data-to-proxy relation.

In general, the multi-head network of the system 100 overcomes this limitation by leveraging from the multi-similarity loss from the pairwise-based class with the proxy-anchor loss from the proxy-based class to enjoy from data-to-data relations while having high convergence rates. The system 100 generates a final objective function which is a combination of proxy-anchor and multi-similarity losses for local and global descriptors that are obtained with second-order spatial attention balanced by λ.

$$ℒ = {ℓ}_{p} + {λℓ}_{m} \qquad ( 7 )$$

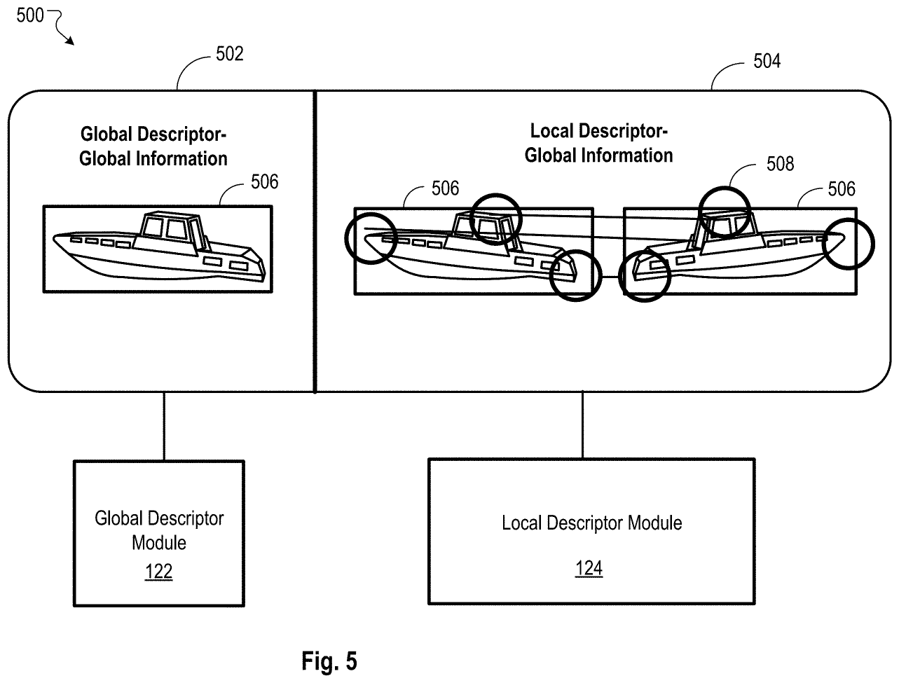

FIG. 5 shows examples of information 500 that includes high-level and low-level features. More specifically, the information 500 includes: i) global descriptors 502 (i.e., low-level features) which can be obtained using global descriptor module 122 and ii) local descriptors 504 (i.e., high-level features) which can be obtained using local descriptor module 124. Representative local features 508 are indicated in the example of FIG. 5 with reference to a sample image 506.

Regarding local descriptors, hand-crafted techniques such as SIFT and SURF have been widely used for retrieval systems especially before the advent of deep learning. Bag-of-Words and related methods rely on visual words obtained via local descriptor clustering. The key advantage of local features over global ones for retrieval is their capability to perform spatial matching, often by utilizing RANSAC. In some cases, different deep learning-based local features can be used, where these features are extracted using the backbone with no requirement for having separate models.

Regarding global descriptors, these descriptors are often involved in the most abstract information about the input, leading to high-performance image retrieval with compact representations. Prior to advances in deep learning, most global descriptors were obtained using the combination of local descriptors. However, current high-performing global features can be based on deep convolutional neural networks, which are trained on classification losses.

Regarding joint local and global descriptors, neural networks can be considered for joint extraction of global and local features. For indoor localization, NetVLAD can be used to extract global features for candidate pose retrieval, followed by dense local feature matching using feature maps from the same network. In some implementations, keypoints are detected in activation maps from global feature models using MSER and activation channels are interpreted as visual words, to propose correspondences between a pair of images. In some other implementations, the global descriptors are used to retrieve the top candidates and the retrieved images can re-ranked by the local descriptor scores.

Some prior approaches only utilize the global features for training and only use the local features for re-ranking. In contrast to these approaches, the described techniques jointly train a multi-head network by concatenation of local and global features, without the requirement of a dimension reduction process that can involve training an autoencoder to reduce the dimension of local descriptors.

As noted above, the system 100 is operable to, using descriptor module 118, combine (e.g., concatenate) global and local descriptors to produce a final descriptor. For example, the system 100 can combine lower-level features and higher-level ones to just one single representation to benefit from the semantic information as well as the spatial information and geometric verification of a given input simultaneously. The single representation can be used to improve feature descriptors for image retrieval and matching.

To facilitate combining the features, the system 100 can generate a weighted sum. For example, based on communications with the descriptor module 118, each learner of the multi-head module 116 is operable to generate a respective score for its global or local descriptors. The multi-head module 116 can then generate a weighted sum from each of the respective scores. For example, the system 100 can generate the weighted sum in response to normalizing/rescaling the respective score to a standardized value that facilitates the combining.

Based on the disclosed techniques, models of system 100 are trained end-to-end for image retrieval and are not limited to mimicking separate pre-trained local and global models. More specifically, the disclosed techniques allow for learning a model by producing and concatenating both local and global features along with second-order attention on a multi-head network.

Regarding deep global and local representations, the system 100 is operable to leverage hierarchical representations from CNNs in order to represent the different types of descriptors to be learned. While global features are associated with deep layers representing high-level cues, local features are more suitable to intermediate layers that encode localized information. Given an image, the system 100 applies a convolutional neural network backbone to obtain at least two feature maps: fₗ∈ [symbol] ^{H}^{ₗ}^{×W×C}^{ₗ} and f_{g}∈ [symbol] ^{H}^{_{g}}^{×W}^{_{g}}^{×C}^{_{g}}, representing local and global feature maps where H, W, C correspond to the height, width and number of channels in each case. For typical convolutional networks, H_{g}≤Hₗ, W_{g}≤Wₗ, and C_{g}≥Cₗ. Deeper layers of the CNN can have spatially smaller maps, with a larger number of channels.

FIG. 6 shows an example process 600 for training a machine-learning model based on a multi-head deep metric learning approach. The steps of process 600 may be performed using one or more of the resources of system 100 as well as other devices and components described in this document. In some implementations, the system 100 uses an algorithm that involves at least two components: i) deep local and global representations and ii) a multi-head loss function that enables the data-to-data relation and fast convergence. In some other implementations, system 100 corresponds to, or includes, one or more neural networks that are implemented on a hardware circuit, such as a special-purpose neural network processor, graphics processing unit (GPU), hardware accelerator, or embedded CPU processor.

The neural network(s) of system 100 can include a pre-trained CNN, e.g., that is configured as a feature generator to perform one or more functions related to automated feature engineering for item recognition or retrieval. The neural networks can include multiple layers, such as a feature layer, one or more intermediate layers, fully-connected layers, and pooling layers. In some implementations, the neural network is a feed-forward feature detector network and the process 600 can apply to an example supervised data classification or data retrieval problem that is addressed using at least the techniques described in this document.

Referring again to FIG. 6, the process 600 trains a model based on input images 602. In the example of FIG. 6, process 600 includes a first process path 603 for processing local/high-level features as well as a second process path 604 for processing global/low-level features. As indicated by the data flow of process 600, the system 100 can include one or more example embedding networks 604a, 606b respectively for each processing path. For example, an Inception network with batch normalization pre-trained for ImageNet classification can be adopted as the embedding networks 606a, 606b. Using embedding networks 606a and 606b, the system 100 can incorporate second-order spatial information into feature pooling and aggregate deep activations in both global and local features using a combination of Global Max Pooling (GMP) and Global Average Pooling (GAP) at the pooling layers 608. In some implementations, the size of the last fully connected layer 610 of the Inception network is changed according to a dimensionality of embedding vectors. The system 100 can generate a layer output (e.g., a final output) from the embedding vectors and then apply L2-normalization to the output.

During an example training sequence, the system 100 can employ an AdamW optimizer, which has the same update step of an Adam optimizer, but decays the weight separately. An example model of system 100 is trained for 40 epochs with initial learning rate 10-4 on the CUB-200-2011 image dataset and Cars-196 dataset, and for 60 epochs with initial learning proxies scaled up 100 times for faster convergence. Input batches are randomly sampled during training. In some implementations, the model is trained with batch size of 150 on a single quadro p5000 GPU.

The system 100 can assign a single proxy for each semantic class following Proxy-NCA. The proxies are initialized using a normal distribution to ensure that they are uniformly distributed on the unit hypersphere. The system 100 can receive and process input images 602 that are augmented by random cropping and horizontal flipping during training. The images may also be center-cropped during testing. In some implementations, a default size of cropped images is 224×224. In some other implementations, the system 100 implements models trained and tested with 256×256 cropped images. The system 100 can have a hyper-parameter setting a and a in equation (4) that is set to 32 and 10-1 respectively for different iterations of training and testing.

The final embeddings 612 involves the concatenation of local and global representations which can be used for the retrieval system 100, to efficiently select the most similar images based on both local and global information simultaneously. In some implementations, the training sequence includes computing or generating an error signal and performing back propagation to update the embedding values of the network to account for the error indicated by the error signal. Based at least on the proxy-anchor loss with respect to image retrieval performance on different benchmark datasets, the accuracy of a trained model of system 100 (i.e., trained using the disclosed techniques) can be measured in three different settings: 64/128 embedding dimension with the default image size (224×224), 512 embedding dimension with the default image size, and 512 embedding dimension with the larger image size (256×256).

An example trained model of system 100 can include a larger crop size and 512 dimensional embedding while achieving improved performance over prior training approaches. In some implementations, an example trained machine-learning model with a low embedding dimension outperforms prior models that employ a high embedding dimension. This suggests that the loss associated with the trained model allows it to learn a more compact yet effective embedding space. Thus, the loss methodology employed by system 100 can boost, or substantially boost, the convergence speed relative to prior approaches for model training.

FIG. 7 is a diagram illustrating an example of a property monitoring system 700. The electronic system 700 includes a network 705, a control unit 710, one or more user devices 740 and 750, a monitoring server 760, and a central alarm station server 770. In some examples, the network 705 facilitates communications between the control unit 710, the one or more user devices 740 and 750, the monitoring server 760, and the central alarm station server 770.

The network 705 is configured to enable exchange of electronic communications between devices connected to the network 705. For example, the network 705 may be configured to enable exchange of electronic communications between the control unit 710, the one or more user devices 740 and 750, the monitoring server 760, and the central alarm station server 770. The network 705 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. Network 705 may include multiple networks or subnetworks, each of which may include, for example, a wired or wireless data pathway. The network 705 may include a circuit-switched network, a packet-switched data network, or any other network able to carry electronic communications (e.g., data or voice communications). For example, the network 705 may include networks based on the Internet protocol (IP), asynchronous transfer mode (ATM), the PSTN, packet-switched networks based on IP, x.25, or Frame Relay, or other comparable technologies and may support voice using, for example, VoIP, or other comparable protocols used for voice communications. The network 705 may include one or more networks that include wireless data channels and wireless voice channels. The network 705 may be a wireless network, a broadband network, or a combination of networks including a wireless network and a broadband network.

The control unit 710 includes a controller 712 and a network module 714. The controller 712 is configured to control a control unit monitoring system (e.g., a control unit system) that includes the control unit 710. In some examples, the controller 712 may include a processor or other control circuitry configured to execute instructions of a program that controls operation of a control unit system. In these examples, the controller 712 may be configured to receive input from sensors, flow meters, or other devices included in the control unit system and control operations of devices included in the household (e.g., speakers, lights, doors, etc.). For example, the controller 712 may be configured to control operation of the network module 714 included in the control unit 710.

The network module 714 is a communication device configured to exchange communications over the network 705. The network module 714 may be a wireless communication module configured to exchange wireless communications over the network 705. For example, the network module 714 may be a wireless communication device configured to exchange communications over a wireless data channel and a wireless voice channel. In this example, the network module 714 may transmit alarm data over a wireless data channel and establish a two-way voice communication session over a wireless voice channel. The wireless communication device may include one or more of a LTE module, a GSM module, a radio modem, cellular transmission module, or any type of module configured to exchange communications in one of the following formats: LTE, GSM or GPRS, CDMA, EDGE or EGPRS, EV-DO or EVDO, UMTS, or IP.

The network module 714 also may be a wired communication module configured to exchange communications over the network 705 using a wired connection. For instance, the network module 714 may be a modem, a network interface card, or another type of network interface device. The network module 714 may be an Ethernet network card configured to enable the control unit 710 to communicate over a local area network and/or the Internet. The network module 714 also may be a voice band modem configured to enable the alarm panel to communicate over the telephone lines of Plain Old Telephone Systems (POTS).

The control unit system that includes the control unit 710 includes one or more sensors. For example, the monitoring system may include multiple sensors 720. The sensors 720 may include a lock sensor, a contact sensor, a motion sensor, or any other type of sensor included in a control unit system. The sensors 720 also may include an environmental sensor, such as a temperature sensor, a water sensor, a rain sensor, a wind sensor, a light sensor, a smoke detector, a carbon monoxide detector, an air quality sensor, etc. The sensors 720 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the home. The health monitoring sensor can collect various health data, including pulse, heart-rate, respiration rate, sugar or glucose level, bodily temperature, or motion data.

The sensors 720 can also include a radio-frequency identification (RFID) sensor that identifies a particular article that includes a pre-assigned RFID tag.

The control unit 710 communicates with the home automation controls 722 and a camera 730 to perform monitoring. The home automation controls 722 are connected to one or more devices that enable automation of actions in the home. For instance, the home automation controls 722 may be connected to one or more lighting systems and may be configured to control operation of the one or more lighting systems. Also, the home automation controls 722 may be connected to one or more electronic locks at the home and may be configured to control operation of the one or more electronic locks (e.g., control Z-Wave locks using wireless communications in the Z-Wave protocol). Further, the home automation controls 722 may be connected to one or more appliances at the home and may be configured to control operation of the one or more appliances. The home automation controls 722 may include multiple modules that are each specific to the type of device being controlled in an automated manner. The home automation controls 722 may control the one or more devices based on commands received from the control unit 710. For instance, the home automation controls 722 may cause a lighting system to illuminate an area to provide a better image of the area when captured by a camera 730.

The camera 730 may be a video/photographic camera or other type of optical sensing device configured to capture images. For instance, the camera 730 may be configured to capture images of an area within a building or home monitored by the control unit 710. The camera 730 may be configured to capture single, static images of the area and also video images of the area in which multiple images of the area are captured at a relatively high frequency (e.g., thirty images per second). The camera 730 may be controlled based on commands received from the control unit 710.

The camera 730 may be triggered by several different types of techniques. For instance, a Passive Infra-Red (PIR) motion sensor may be built into the camera 730 and used to trigger the camera 730 to capture one or more images when motion is detected. The camera 730 also may include a microwave motion sensor built into the camera and used to trigger the camera 730 to capture one or more images when motion is detected. The camera 730 may have a “normally open” or “normally closed” digital input that can trigger capture of one or more images when external sensors (e.g., the sensors 720, PIR, door/window, etc.) detect motion or other events. In some implementations, the camera 730 receives a command to capture an image when external devices detect motion or another potential alarm event. The camera 730 may receive the command from the controller 712 or directly from one of the sensors 720.

In some examples, the camera 730 triggers integrated or external illuminators (e.g., Infra-Red, Z-wave controlled “white” lights, lights controlled by the home automation controls 722, etc.) to improve image quality when the scene is dark. An integrated or separate light sensor may be used to determine if illumination is desired and may result in increased image quality.

The camera 730 may be programmed with any combination of time/day schedules, system “arming state”, or other variables to determine whether images should be captured or not when triggers occur. The camera 730 may enter a low-power mode when not capturing images. In this case, the camera 730 may wake periodically to check for inbound messages from the controller 712. The camera 730 may be powered by internal, replaceable batteries if located remotely from the control unit 710. The camera 730 may employ a small solar cell to recharge the battery when light is available. Alternatively, the camera 730 may be powered by the controller's 712 power supply if the camera 730 is co-located with the controller 712.

In some implementations, the camera 730 communicates directly with the monitoring server 760 over the Internet. In these implementations, image data captured by the camera 730 does not pass through the control unit 710 and the camera 730 receives commands related to operation from the monitoring server 760.

The system 700 also includes thermostat 734 to perform dynamic environmental control at the home. The thermostat 734 is configured to monitor temperature and/or energy consumption of an HVAC system associated with the thermostat 734, and is further configured to provide control of environmental (e.g., temperature) settings. In some implementations, the thermostat 734 can additionally or alternatively receive data relating to activity at a home and/or environmental data at a home, e.g., at various locations indoors and outdoors at the home. The thermostat 734 can directly measure energy consumption of the HVAC system associated with the thermostat, or can estimate energy consumption of the HVAC system associated with the thermostat 734, for example, based on detected usage of one or more components of the HVAC system associated with the thermostat 734. The thermostat 734 can communicate temperature and/or energy monitoring information to or from the control unit 710 and can control the environmental (e.g., temperature) settings based on commands received from the control unit 710.

In some implementations, the thermostat 734 is a dynamically programmable thermostat and can be integrated with the control unit 710. For example, the dynamically programmable thermostat 734 can include the control unit 710, e.g., as an internal component to the dynamically programmable thermostat 734. In addition, the control unit 710 can be a gateway device that communicates with the dynamically programmable thermostat 734. In some implementations, the thermostat 734 is controlled via one or more home automation controls 722.

A module 737 is connected to one or more components of an HVAC system associated with a home, and is configured to control operation of the one or more components of the HVAC system. In some implementations, the module 737 is also configured to monitor energy consumption of the HVAC system components, for example, by directly measuring the energy consumption of the HVAC system components or by estimating the energy usage of the one or more HVAC system components based on detecting usage of components of the HVAC system. The module 737 can communicate energy monitoring information 576 and the state of the HVAC system components to the thermostat 734 and can control the one or more components of the HVAC system based on commands received from the thermostat 734.

The system 700 includes one or more object recognition engines 757. Each of the one or more object recognition engine 757 connects to control unit 710, e.g., through network 705. The object recognition engines 757 can be computing devices (e.g., a computer, microcontroller, FPGA, ASIC, or other device capable of electronic computation) capable of receiving data related to the sensors 720 and communicating electronically with the monitoring system control unit 710 and monitoring server 760.

The object recognition engine 757 receives data from one or more sensors 720. In some examples, the object recognition engine 757 can be used to item/object recognition based on data (e.g., image data) generated by sensors 720 (e.g., data from sensor 720 describing motion, video content, and other parameters). The object recognition engine 757 can receive data from the one or more sensors 720 through any combination of wired and/or wireless data links. For example, the object recognition engine 757 can receive sensor data via a Bluetooth, Bluetooth LE, Z-wave, or Zigbee data link.

The object recognition engine 757 communicates electronically with the control unit 710. For example, the object recognition engine 757 can send data related to the sensors 720 to the control unit 710 and receive commands related to determining or retrieving image content based on data from the sensors 720. In some examples, the object recognition engine 757 processes or generates sensor signal data, for signals emitted by the sensors 720, prior to sending it to the control unit 710. The sensor signal data can a descriptor that indicates a retrieved image or an object detect in an image.

In some examples, the system 700 further includes one or more robotic devices 790. The robotic devices 790 may be any type of robots that are capable of moving and taking actions that assist in home monitoring. For example, the robotic devices 790 may include drones that are capable of moving throughout a home based on automated control technology and/or user input control provided by a user. In this example, the drones may be able to fly, roll, walk, or otherwise move about the home. The drones may include helicopter type devices (e.g., quad copters), rolling helicopter type devices (e.g., roller copter devices that can fly and also roll along the ground, walls, or ceiling) and land vehicle type devices (e.g., automated cars that drive around a home). In some cases, the robotic devices 790 may be devices that are intended for other purposes and merely associated with the system 700 for use in appropriate circumstances. For instance, a robotic vacuum cleaner device may be associated with the monitoring system 700 as one of the robotic devices 790 and may be controlled to take action responsive to monitoring system events.

In some examples, the robotic devices 790 automatically navigate within a home. In these examples, the robotic devices 790 include sensors and control processors that guide movement of the robotic devices 790 within the home. For instance, the robotic devices 790 may navigate within the home using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 790 may include control processors that process output from the various sensors and control the robotic devices 790 to move along a path that reaches the desired destination and avoids obstacles. In this regard, the control processors detect walls or other obstacles in the home and guide movement of the robotic devices 790 in a manner that avoids the walls and other obstacles.

In addition, the robotic devices 790 may store data that describes attributes of the home. For instance, the robotic devices 790 may store a floorplan and/or a three-dimensional model of the home that enables the robotic devices 790 to navigate the home. During initial configuration, the robotic devices 790 may receive the data describing attributes of the home, determine a frame of reference to the data (e.g., a home or reference location in the home), and navigate the home based on the frame of reference and the data describing attributes of the home. Further, initial configuration of the robotic devices 790 also may include learning of one or more navigation patterns in which a user provides input to control the robotic devices 790 to perform a specific navigation action (e.g., fly to an upstairs bedroom and spin around while capturing video and then return to a home charging base). In this regard, the robotic devices 790 may learn and store the navigation patterns such that the robotic devices 790 may automatically repeat the specific navigation actions upon a later request.

In some examples, the robotic devices 790 may include data capture and recording devices. In these examples, the robotic devices 790 may include one or more cameras, one or more motion sensors, one or more microphones, one or more biometric data collection tools, one or more temperature sensors, one or more humidity sensors, one or more air flow sensors, and/or any other types of sensors that may be useful in capturing monitoring data related to the home and users in the home. The one or more biometric data collection tools may be configured to collect biometric samples of a person in the home with or without contact of the person. For instance, the biometric data collection tools may include a fingerprint scanner, a hair sample collection tool, a skin cell collection tool, and/or any other tool that allows the robotic devices 790 to take and store a biometric sample that can be used to identify the person (e.g., a biometric sample with DNA that can be used for DNA testing).

In some implementations, the robotic devices 790 may include output devices. In these implementations, the robotic devices 790 may include one or more displays, one or more speakers, and/or any type of output devices that allow the robotic devices 790 to communicate information to a nearby user.

The robotic devices 790 also may include a communication module that enables the robotic devices 790 to communicate with the control unit 710, each other, and/or other devices. The communication module may be a wireless communication module that allows the robotic devices 790 to communicate wirelessly. For instance, the communication module may be a Wi-Fi module that enables the robotic devices 790 to communicate over a local wireless network at the home. The communication module further may be a 900 MHz wireless communication module that enables the robotic devices 790 to communicate directly with the control unit 710. Other types of short-range wireless communication protocols, such as Bluetooth, Bluetooth LE, Z-wave, Zigbee, etc., may be used to allow the robotic devices 790 to communicate with other devices in the home. In some implementations, the robotic devices 790 may communicate with each other or with other devices of the system 700 through the network 705.

The robotic devices 790 further may include processor and storage capabilities. The robotic devices 790 may include any suitable processing devices that enable the robotic devices 790 to operate applications and perform the actions described throughout this disclosure. In addition, the robotic devices 790 may include solid state electronic storage that enables the robotic devices 790 to store applications, configuration data, collected sensor data, and/or any other type of information available to the robotic devices 790.

The robotic devices 790 are associated with one or more charging stations. The charging stations may be located at predefined home base or reference locations in the home. The robotic devices 790 may be configured to navigate to the charging stations after completion of tasks needed to be performed for the monitoring system 700. For instance, after completion of a monitoring operation or upon instruction by the control unit 710, the robotic devices 790 may be configured to automatically fly to and land on one of the charging stations. In this regard, the robotic devices 790 may automatically maintain a fully charged battery in a state in which the robotic devices 790 are ready for use by the monitoring system 700.

The charging stations may be contact based charging stations and/or wireless charging stations. For contact based charging stations, the robotic devices 790 may have readily accessible points of contact that the robotic devices 790 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 790 may charge through a wireless exchange of power. In these cases, the robotic devices 790 need only locate themselves closely enough to the wireless charging stations for the wireless exchange of power to occur. In this regard, the positioning needed to land at a predefined home base or reference location in the home may be less precise than with a contact based charging station. Based on the robotic devices 790 landing at a wireless charging station, the wireless charging station outputs a wireless signal that the robotic devices 790 receive and convert to a power signal that charges a battery maintained on the robotic devices 790.

In some implementations, each of the robotic devices 790 has a corresponding and assigned charging station such that the number of robotic devices 790 equals the number of charging stations. In these implementations, the robotic devices 790 always navigate to the specific charging station assigned to that robotic device. For instance, a first robotic device may always use a first charging station and a second robotic device may always use a second charging station.

In some examples, the robotic devices 790 may share charging stations. For instance, the robotic devices 790 may use one or more community charging stations that are capable of charging multiple robotic devices 790. The community charging station may be configured to charge multiple robotic devices 790 in parallel. The community charging station may be configured to charge multiple robotic devices 790 in serial such that the multiple robotic devices 790 take turns charging and, when fully charged, return to a predefined home base or reference location in the home that is not associated with a charger. The number of community charging stations may be less than the number of robotic devices 790.

Also, the charging stations may not be assigned to specific robotic devices 790 and may be capable of charging any of the robotic devices 790. In this regard, the robotic devices 790 may use any suitable, unoccupied charging station when not in use. For instance, when one of the robotic devices 790 has completed an operation or is in need of battery charge, the control unit 710 references a stored table of the occupancy status of each charging station and instructs the robotic device to navigate to the nearest charging station that is unoccupied.

The system 700 further includes one or more integrated security devices 780. The one or more integrated security devices may include any type of device used to provide alerts based on received sensor data. For instance, the one or more control units 710 may provide one or more alerts to the one or more integrated security input/output devices 780. Additionally, the one or more control units 710 may receive one or more sensor data from the sensors 720 and determine whether to provide an alert to the one or more integrated security input/output devices 780.

The sensors 720, the home automation controls 722, the camera 730, the thermostat 734, and the integrated security devices 780 may communicate with the controller 712 over communication links 724, 726, 728, 732, 738, 736, and 784. The communication links 724, 726, 728, 732, 738, and 784 may be a wired or wireless data pathway configured to transmit signals from the sensors 720, the home automation controls 722, the camera 730, the thermostat 734, and the integrated security devices 780 to the controller 712. The sensors 720, the home automation controls 722, the camera 730, the thermostat 734, and the integrated security devices 780 may continuously transmit sensed values to the controller 712, periodically transmit sensed values to the controller 712, or transmit sensed values to the controller 712 in response to a change in a sensed value.

The communication links 724, 726, 728, 732, 738, and 784 may include a local network. The sensors 720, the home automation controls 722, the camera 730, the thermostat 734, and the integrated security devices 780, and the controller 712 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CAT5) or Category 6 (CAT6) wired Ethernet network. The local network may be a mesh network constructed based on the devices connected to the mesh network.

The monitoring server 760 is an electronic device configured to provide monitoring services by exchanging electronic communications with the control unit 710, the one or more user devices 740 and 750, and the central alarm station server 770 over the network 705. For example, the monitoring server 760 may be configured to monitor events (e.g., alarm events) generated by the control unit 710. In this example, the monitoring server 760 may exchange electronic communications with the network module 714 included in the control unit 710 to receive information regarding events (e.g., alerts) detected by the control unit 710. The monitoring server 760 also may receive information regarding events (e.g., alerts) from the one or more user devices 740 and 750.

In some examples, the monitoring server 760 may route alert data received from the network module 714 or the one or more user devices 740 and 750 to the central alarm station server 770. For example, the monitoring server 760 may transmit the alert data to the central alarm station server 770 over the network 705.

The monitoring server 760 may store sensor and image data received from the monitoring system and perform analysis of sensor and image data received from the monitoring system. Based on the analysis, the monitoring server 760 may communicate with and control aspects of the control unit 710 or the one or more user devices 740 and 750.

The monitoring server 760 may provide various monitoring services to the system 700. For example, the monitoring server 760 may analyze the sensor, image, and other data to determine an activity pattern of a resident of the home monitored by the system 700. In some implementations, the monitoring server 760 may analyze the data for alarm conditions or may determine and perform actions at the home by issuing commands to one or more of the controls 722, possibly through the control unit 710.

The central alarm station server 770 is an electronic device configured to provide alarm monitoring service by exchanging communications with the control unit 710, the one or more mobile devices 740 and 750, and the monitoring server 760 over the network 705. For example, the central alarm station server 770 may be configured to monitor alerting events generated by the control unit 710. In this example, the central alarm station server 770 may exchange communications with the network module 714 included in the control unit 710 to receive information regarding alerting events detected by the control unit 710. The central alarm station server 770 also may receive information regarding alerting events from the one or more mobile devices 740 and 750 and/or the monitoring server 760.

The central alarm station server 770 is connected to multiple terminals 772 and 774. The terminals 772 and 774 may be used by operators to process alerting events. For example, the central alarm station server 770 may route alerting data to the terminals 772 and 774 to enable an operator to process the alerting data. The terminals 772 and 774 may include general-purpose computers (e.g., desktop personal computers, workstations, or laptop computers) that are configured to receive alerting data from a server in the central alarm station server 770 and render a display of information based on the alerting data. For instance, the controller 712 may control the network module 714 to transmit, to the central alarm station server 770, alerting data indicating that a sensor 720 detected motion from a motion sensor via the sensors 720. The central alarm station server 770 may receive the alerting data and route the alerting data to the terminal 772 for processing by an operator associated with the terminal 772. The terminal 772 may render a display to the operator that includes information associated with the alerting event (e.g., the lock sensor data, the motion sensor data, the contact sensor data, etc.) and the operator may handle the alerting event based on the displayed information.

In some implementations, the terminals 772 and 774 may be mobile devices or devices designed for a specific function. Although FIG. 7 illustrates two terminals for brevity, actual implementations may include more (and, perhaps, many more) terminals.

The one or more authorized user devices 740 and 750 are devices that host and display user interfaces. For instance, the user device 740 is a mobile device that hosts or runs one or more native applications (e.g., the smart home application 742). The user device 740 may be a cellular phone or a non-cellular locally networked device with a display. The user device 740 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 740 may perform functions unrelated to the monitoring system, such as placing personal telephone calls, playing music, playing video, displaying pictures, browsing the Internet, maintaining an electronic calendar, etc.

The user device 740 includes a smart home application 742. The smart home application 742 refers to a software/firmware program running on the corresponding mobile device that enables the user interface and features described throughout. The user device 740 may load or install the smart home application 742 based on data received over a network or data received from local media. The smart home application 742 runs on mobile devices platforms, such as iPhone, iPod touch, Blackberry, Google Android, Windows Mobile, etc. The smart home application 742 enables the user device 740 to receive and process image and sensor data from the monitoring system.

The user device 750 may be a general-purpose computer (e.g., a desktop personal computer, a workstation, or a laptop computer) that is configured to communicate with the monitoring server 760 and/or the control unit 710 over the network 705. The user device 750 may be configured to display a smart home user interface 752 that is generated by the user device 750 or generated by the monitoring server 760. For example, the user device 750 may be configured to display a user interface (e.g., a web page) provided by the monitoring server 760 that enables a user to perceive images captured by the camera 730 and/or reports related to the monitoring system. Although FIG. 5 illustrates two user devices for brevity, actual implementations may include more (and, perhaps, many more) or fewer user devices.

In some implementations, the one or more user devices 740 and 750 communicate with and receive monitoring system data from the control unit 710 using the communication link 738. For instance, the one or more user devices 740 and 750 may communicate with the control unit 710 using various local wireless protocols such as Wi-Fi, Bluetooth, Z-wave, Zigbee, HomePlug (ethernet over power line), or wired protocols such as Ethernet and USB, to connect the one or more user devices 740 and 750 to local security and automation equipment. The one or more user devices 740 and 750 may connect locally to the monitoring system and its sensors and other devices. The local connection may improve the speed of status and control communications because communicating through the network 705 with a remote server (e.g., the monitoring server 760) may be significantly slower.

Although the one or more user devices 740 and 750 are shown as communicating with the control unit 710, the one or more user devices 740 and 750 may communicate directly with the sensors and other devices controlled by the control unit 710. In some implementations, the one or more user devices 740 and 750 replace the control unit 710 and perform the functions of the control unit 710 for local monitoring and long range/offsite communication.

In other implementations, the one or more user devices 740 and 750 receive monitoring system data captured by the control unit 710 through the network 705. The one or more user devices 740, 750 may receive the data from the control unit 710 through the network 705 or the monitoring server 760 may relay data received from the control unit 710 to the one or more user devices 740 and 750 through the network 705. In this regard, the monitoring server 760 may facilitate communication between the one or more user devices 740 and 750 and the monitoring system.

In some implementations, the one or more user devices 740 and 750 may be configured to switch whether the one or more user devices 740 and 750 communicate with the control unit 710 directly (e.g., through link 738) or through the monitoring server 760 (e.g., through network 705) based on a location of the one or more user devices 740 and 750. For instance, when the one or more user devices 740 and 750 are located close to the control unit 710 and in range to communicate directly with the control unit 710, the one or more user devices 740 and 750 use direct communication. When the one or more user devices 740 and 750 are located far from the control unit 710 and not in range to communicate directly with the control unit 710, the one or more user devices 740 and 750 use communication through the monitoring server 760.

Although the one or more user devices 740 and 750 are shown as being connected to the network 705, in some implementations, the one or more user devices 740 and 750 are not connected to the network 705. In these implementations, the one or more user devices 740 and 750 communicate directly with one or more of the monitoring system components and no network (e.g., Internet) connection or reliance on remote servers is needed.

In some implementations, the one or more user devices 740 and 750 are used in conjunction with only local sensors and/or local devices in a house. In these implementations, the system 700 includes the one or more user devices 740 and 750, the sensors 720, the home automation controls 722, the camera 730, the robotic devices 790, and the object recognition engine 757. The one or more user devices 740 and 750 receive data directly from the sensors 720, the home automation controls 722, the camera 730, the robotic devices 790, and the object recognition engine 757 and sends data directly to the sensors 720, the home automation controls 722, the camera 730, the robotic devices 790, and the object recognition engine 757. The one or more user devices 740, 750 provide the appropriate interfaces/processing to provide visual surveillance and reporting.

In other implementations, the system 700 further includes network 705 and the sensors 720, the home automation controls 722, the camera 730, the thermostat 734, the robotic devices 790, and the object recognition engine 757 are configured to communicate sensor and image data to the one or more user devices 740 and 750 over network 705 (e.g., the Internet, cellular network, etc.). In yet another implementation, the sensors 720, the home automation controls 722, the camera 730, the thermostat 734, the robotic devices 790, and the object recognition engine 757 (or a component, such as a bridge/router) are intelligent enough to change the communication pathway from a direct local pathway when the one or more user devices 740 and 750 are in close physical proximity to the sensors 720, the home automation controls 722, the camera 730, the thermostat 734, the robotic devices 790, and the object recognition engine 757 to a pathway over network 705 when the one or more user devices 740 and 750 are farther from the sensors 720, the home automation controls 722, the camera 730, the thermostat 734, the robotic devices 790, and the object recognition engine.

In some examples, the system leverages GPS information from the one or more user devices 740 and 750 to determine whether the one or more user devices 740 and 750 are close enough to the sensors 720, the home automation controls 722, the camera 730, the thermostat 734, the robotic devices 790, and the object recognition engine 757 to use the direct local pathway or whether the one or more user devices 740 and 750 are far enough from the sensors 720, the home automation controls 722, the camera 730, the thermostat 734, the robotic devices 790, and the object recognition engine 757 that the pathway over network 705 is required.

In other examples, the system leverages status communications (e.g., pinging) between the one or more user devices 740 and 750 and the sensors 720, the home automation controls 722, the camera 730, the thermostat 734, the robotic devices 790, and the object recognition engine 757 to determine whether communication using the direct local pathway is possible. If communication using the direct local pathway is possible, the one or more user devices 740 and 750 communicate with the sensors 720, the home automation controls 722, the camera 730, the thermostat 734, the robotic devices 790, and the object recognition engine 757 using the direct local pathway. If communication using the direct local pathway is not possible, the one or more user devices 740 and 750 communicate with the sensors 720, the home automation controls 722, the camera 730, the thermostat 734, the robotic devices 790, and the object recognition engine 757 using the pathway over network 705.

In some implementations, the system 700 provides end users with access to images captured by the camera 730 to aid in decision making. The system 700 may transmit the images captured by the camera 730 over a wireless WAN network to the user devices 740 and 750. Because transmission over a wireless WAN network may be relatively expensive, the system 700 can use several techniques to reduce costs while providing access to significant levels of useful visual information (e.g., compressing data, down-sampling data, sending data only over inexpensive LAN connections, or other techniques).

In some implementations, a state of the monitoring system and other events sensed by the monitoring system may be used to enable/disable video/image recording devices (e.g., the camera 730). In these implementations, the camera 730 may be set to capture images on a periodic basis when the alarm system is armed in an “away” state, but set not to capture images when the alarm system is armed in a “home” state or disarmed. In addition, the camera 730 may be triggered to begin capturing images when the alarm system detects an event, such as an alarm event, a door-opening event for a door that leads to an area within a field of view of the camera 730, or motion in the area within the field of view of the camera 730. In other implementations, the camera 730 may capture images continuously, but the captured images may be stored or transmitted over a network when needed.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer.

Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method implemented using a machine-learning architecture, the method comprising:
obtaining a plurality of features derived from data values of an input dataset;
identifying, for an input image of the input dataset, global features and local features among the plurality of features;
determining a first set of vectors from the global features and a second set of vectors from the local features;
computing, from the first and second sets of vectors, a concatenated feature set based on a proxy-based loss function and pairwise-based loss function;
generating, based on the concatenated feature set, a feature representation that integrates the global features and the local features; and
generating a machine-learning model configured to output a prediction about an image based on inferences derived using the feature representation.

2. The method of claim 1, comprising:
generating a first set of embeddings corresponding to the first set of vectors based on the proxy-based loss function and the pairwise-based loss function; and
generating a second set of embeddings corresponding to the second set of vectors based on the proxy-based loss function and the pairwise-based loss function.

3. The method of claim 2, wherein generating a feature representation comprises:
generating, from the first and second sets of embeddings, a final embedding output that is representative of content information, geometry information, and spatial information of the input image.

4. The method of claim 1, wherein identifying the global features and the local features comprises:
encoding, using an encoder module of the architecture, the input image to an attribute range comprising a range that spans from low-level descriptors of the input image to high-level descriptors of the input image.

5. The method of claim 1, wherein determining the first set of vectors from the global features comprises:
generating an enhanced set of global features in response to processing the global features by a first second-order attention block; and
determining the first set of vectors from the enhanced set of global features.

6. The method of claim 5, wherein:
the enhanced set of global features comprises second-order information from spatial locations in high-level descriptors of the input image.

7. The method of claim 6, wherein determining the second set of vectors from the local features comprises:
generating an enhanced set of local features in response to processing the local features by a second second-order attention block; and
determining the second set of vectors from the enhanced set of local features.

8. The method of claim 7, wherein:
the enhanced set of local features comprises second-order information from spatial locations in local-level descriptors of the input image.

9. The method of claim 1, wherein:
the input dataset comprises a plurality of images; and
the data values of the input dataset are image pixel values for at least one image.

10. A system comprising a processing device and a non-transitory machine-readable storage device storing instructions that are executable by the processing device to cause performance of operations comprising:
obtaining a plurality of features derived from data values of an input dataset;
identifying, for an input image of the input dataset, global features and local features among the plurality of features;
determining a first set of vectors from the global features and a second set of vectors from the local features;
computing, from the first and second sets of vectors, a concatenated feature set based on a proxy-based loss function and pairwise-based loss function;
generating, based on the concatenated feature set, a feature representation that integrates the global features and the local features; and
generating a machine-learning model configured to output a prediction about an image based on inferences derived using the feature representation.

11. The system of claim 10, wherein the operations comprise:
generating a first set of embeddings corresponding to the first set of vectors based on the proxy-based loss function and the pairwise-based loss function; and
generating a second set of embeddings corresponding to the second set of vectors based on the proxy-based loss function and the pairwise-based loss function.

12. The system of claim 11, wherein generating a feature representation comprises:
generating, from the first and second sets of embeddings, a final embedding output that is representative of content information, geometry information, and spatial information of the input image.

13. The system of claim 10, wherein identifying the global features and the local features comprises:
encoding, using an encoder module of the architecture, the input image to an attribute range comprising a range that spans from low-level descriptors of the input image to high-level descriptors of the input image.

14. The system of claim 10, wherein determining the first set of vectors from the global features comprises:
generating an enhanced set of global features in response to processing the global features by a first second-order attention block; and
determining the first set of vectors from the enhanced set of global features.

15. The system of claim 14, wherein:
the enhanced set of global features comprises second-order information from spatial locations in high-level descriptors of the input image.

16. The system of claim 15, wherein determining the second set of vectors from the local features comprises:
generating an enhanced set of local features in response to processing the local features by a second second-order attention block; and
determining the second set of vectors from the enhanced set of local features.

17. The system of claim 16, wherein:
the enhanced set of local features comprises second-order information from spatial locations in local-level descriptors of the input image.

18. The system of claim 10, wherein:
the input dataset comprises a plurality of images; and
the data values of the input dataset are image pixel values for at least one image.

19. A non-transitory machine-readable storage device storing instructions that are executable by a processing device to cause performance of operations comprising:
obtaining a plurality of features derived from data values of an input dataset;
identifying, for an input image of the input dataset, global features and local features among the plurality of features;
determining a first set of vectors from the global features and a second set of vectors from the local features;
computing, from the first and second sets of vectors, a concatenated feature set based on a proxy-based loss function and pairwise-based loss function;
generating, based on the concatenated feature set, a feature representation that integrates the global features and the local features; and
generating a machine-learning model configured to output a prediction about an image based on inferences derived using the feature representation.

20. The non-transitory machine-readable storage device of claim 19, wherein the operations comprise:
generating a first set of embeddings corresponding to the first set of vectors based on the proxy-based loss function and the pairwise-based loss function; and
generating a second set of embeddings corresponding to the second set of vectors based on the proxy-based loss function and the pairwise-based loss function.
